(19) United States
(12) Patent Application Publication
(10) Pub. No.: US 2025/0388140 A1
(43) Pub. Date: Dec. 25, 2025

(54) VEHICLE SEAT

(71) Applicant: TACHI-S CO., LTD., Tokyo (JP)

(72) Inventors: Takuya Haraguchi, Tokyo (JP); Takahiko Suzuki, Tokyo (JP); Kouichi Moroi, Tokyo (JP); Jyunichi Utsumi, Tokyo (JP)

(73) Assignee: TACHI-S CO., LTD., Tokyo (JP)

(21) Appl. No.: 19/240,299

(22) Filed: Jun. 17, 2025

(30) Foreign Application Priority Data
Jun. 20, 2024 (JP) 2024-099730

(51) Int. Cl. B60N 2/58

(52) U.S. Cl. CPC B60N 2/5825

(57) ABSTRACT

The present invention provides a vehicle seat that can provide a large space for a rear seat with reduced manufacturing cost. A pair of suspenders 7a and 7b spaced apart in the up-down direction and a pair of hooks 8a and 8b spaced apart in the left-right direction pull a back skin 5a forward so as to form a recess 52 recessed forward in the back skin 5a. Thus, a recess is formed in the rear surface of a seatback 3 (a back frame 30) without using a resin panel board. Hence, a large space is provided for an occupant seated on the seat behind a vehicle seat 1 with reduced manufacturing cost of the vehicle seat 1.

### BACKGROUND OF THE INVENTION

### 1. Field of the Invention

The present invention relates to a vehicle seat, and more specifically to a vehicle seat that can provide a large space for a rear seat with reduced manufacturing cost.

### 2. Description of the Related Art

For example, Japanese Unexamined Patent Application Publication No. 2019-104403 (e.g., paragraphs 0020 to 0023, 0027, and FIGS. 2 and 3) discloses a technique in which a seatback board 21 including a plate member 22 and a skin member 23 joined to the plate member 22 covers the rear side of a seatback 3. The plate member 22 is provided with a recess 33 recessed forward to provide a large space for an occupant seated on a seat behind the seatback 3.

However, in this related art technique, because substantially the entire rear surface of the seatback 3 is covered with the backboard 21, the plate member 22, which is made of resin, needs to be relatively large. This leads to a problem of increased manufacturing cost of the vehicle seat.

The present invention has been made to solve the above-described problem, and an object thereof is to provide a vehicle seat that can provide a large space for a rear seat with reduced manufacturing cost.

### SUMMARY OF THE INVENTION

A vehicle seat of the present invention includes a seatback including: a seat pad; a back frame having a support member that supports, on a front surface thereof, the seat pad; a back skin that covers a rear side of the back frame; and a suspension member that connects the back skin to at least one of the support member and a first engaging member embedded in the seat pad. The suspension member includes at least a pair of first suspension members spaced apart in an up-down direction and a pair of second suspension members spaced apart in a left-right direction. The back skin is pulled forward by the pair of first suspension members and the pair of second suspension members so as to form a recess recessed forward in the back skin.

According to the vehicle seat of the first aspect, the suspension member that connects the back skin to at least one of the support member and the first engaging member embedded in the seat pad includes at least a pair of first suspension members spaced apart in the up-down direction and a pair of second suspension members spaced apart in the left-right direction. As a result of the pair of first suspension members and the pair of second suspension members pulling the back skin forward, the recess recessed forward is formed in the back skin. Thus, it is possible to form the recess in the rear side of the seatback without using a resin panel board. This provides a large space for an occupant seated on the seat behind the vehicle seat with reduced manufacturing cost of the vehicle seat, which is advantageous.

The vehicle seat of the second aspect has the following advantage in addition to the advantage provided by the vehicle seat of the first aspect. Because at least one of the pair of first suspension members and the pair of second suspension members connect the back skin to the support member, the support member has the function of pulling the back skin forward in addition to the function of supporting the seat pad. Because there is no need to provide a separate component for pulling the back skin forward, there is an advantage in that the manufacturing cost of the vehicle seat is reduced.

The vehicle seat of the third aspect has the following advantage in addition to the advantage provided by the vehicle seat of the first aspect. At least one of the pair of first suspension members and the pair of second suspension members connect the back skin to the engaging member embedded in the seat pad. Thus, the arrangement of the engaging member can be easily adjusted according to the arrangement of the pair of first suspension members and the pair of second suspension members by changing the position where the engaging member is embedded in the seat pad. Because the arrangement of the pair of first suspension members and the pair of second suspension members is less likely to be restricted, there is an advantage in that the degree of freedom in design of the vehicle seat is improved.

The vehicle seat of the fourth aspect has the following advantage in addition to the advantage provided by the vehicle seat of the first aspect. The back skin includes a rectangular bottom skin forming the bottom surface of the recess. The back skin has a first seam and a second seam extending along upper and lower sides of the bottom skin, and a third seam and a fourth seam extending along left and right sides of the bottom skin. The pair of first suspension members pull the first seam and the second seam forward, and the pair of second suspension members pull the third seam and the fourth seam forward. Thus, each of the four sides of the bottom skin is easily pulled forward. With this structure, the bottom skin is less likely to wrinkle. Thus, there is an advantage in that the appearance of the vehicle seat is improved.

The vehicle seat of the fifth aspect has the following advantage in addition to the advantage provided by the vehicle seat of the fourth aspect. The back skin has a fifth seam and a sixth seam extending downward from the bottom skin along the third seam and the fourth seam. The pair of first suspension members are sewn to seam allowances of the first seam and the second seam. The pair of second suspension members are sewn to seam allowances of the fifth seam and the sixth seam. This makes it possible to pull the first to fourth seams extending along the four sides of the bottom skin forward with the pair of first suspension members and the pair of second suspension members, and also to directly pull the fifth seam and the sixth seam located below the bottom skin forward with the pair of second suspension members. This increases the area of the back skin pulled forward while preventing the bottom skin from wrinkling. This leads to an advantage in that it is possible to provide a large space for an occupant seated on the seat behind the vehicle seat while improving the appearance of the vehicle seat.

The vehicle seat of the sixth aspect has the following advantage in addition to the advantage provided by the vehicle seat of the fifth aspect. Because the first seam and the second seam are pulled forward by the pair of first suspension members inclined upward and forward, the upper and lower sides of the bottom skin extending along the first and second seams are easily pulled upward. Meanwhile, as described above, because the pair of second suspension members are sewn to the fifth seam and the sixth seam extending downward from the third seam and the fourth seam, the left and right sides of the bottom skin extending along the third and fourth seams are easily pulled downward. By pulling the upper and lower sides of the bottom skin upward and pulling the left and right sides downward in this way, the bottom skin is less likely to wrinkle. This leads to an advantage in that the appearance of the vehicle seat is improved.

According to the vehicle seat of the seventh aspect, in addition to the advantage provided by the vehicle seat of the fourth aspect, because the bottom skin is pulled further forward than a first virtual plane that is in contact with the rear surface at the upper end and the rear surface at the lower end of the seatback, the recess formed in the back skin can be made deep. This leads to an advantage in that it is possible to provide a large space for an occupant seated on the seat behind the vehicle seat.

The vehicle seat of the eighth aspect has the following advantage in addition to the advantage provided by the vehicle seat of the seventh aspect. The back frame includes a pair of left and right side frames extending in the up-down direction, an upper-part frame connecting upper ends of the pair of side frames to each other in the left-right direction, and a lower-part frame connecting lower ends of the pair of side frames to each other in the left-right direction. Because the bottom skin is pulled further forward than a second virtual plane that is in contact with the upper-part frame and the lower-part frame on the rear side of the back frame, the recess formed in the back skin can be made deeper. This leads to an advantage in that it is possible to provide a large space for an occupant seated on the seat behind the vehicle seat.

The vehicle seat of the ninth aspect has the following advantage in addition to the advantage provided by the vehicle seat of the third aspect. The seatback includes a front skin covering a front side of the seat pad, and a third suspension member connecting the front skin to a second engaging member embedded in the seat pad. The seat pad has a rear recess formed in a rear surface of the seat pad and in which the first engaging member is embedded, and a front recess formed in a front surface of the seat pad and in which the second engaging member is embedded. Because the rear recess and the front recess are formed at positions shifted from each other in the up-down direction, the seat pad is prevented from being locally reduced in thickness. This leads to an advantage in that cushioning of the seat pad is uniform.

### BRIEF DESCRIPTION OF THE DRAWINGS

FIG. 1 is a rear perspective view of a vehicle seat.

FIG. 2 is a rear view of the vehicle seat as viewed from a direction II in FIG. 1.

FIG. 3 is a partially enlarged sectional view of the vehicle seat taken along line III-III in FIG. 2.

FIG. 4 is a partially enlarged sectional view of the vehicle seat taken along line IV-IV in FIG. 2.

FIG. 5 is a partially enlarged sectional view of the vehicle seat in which a part of FIG. 3 is enlarged.

FIG. 6 is a partially enlarged sectional view of the vehicle seat, illustrating a state in which an object is inserted into a back pocket from the state in FIG. 5.

### DESCRIPTION OF THE PREFERRED EMBODIMENTS

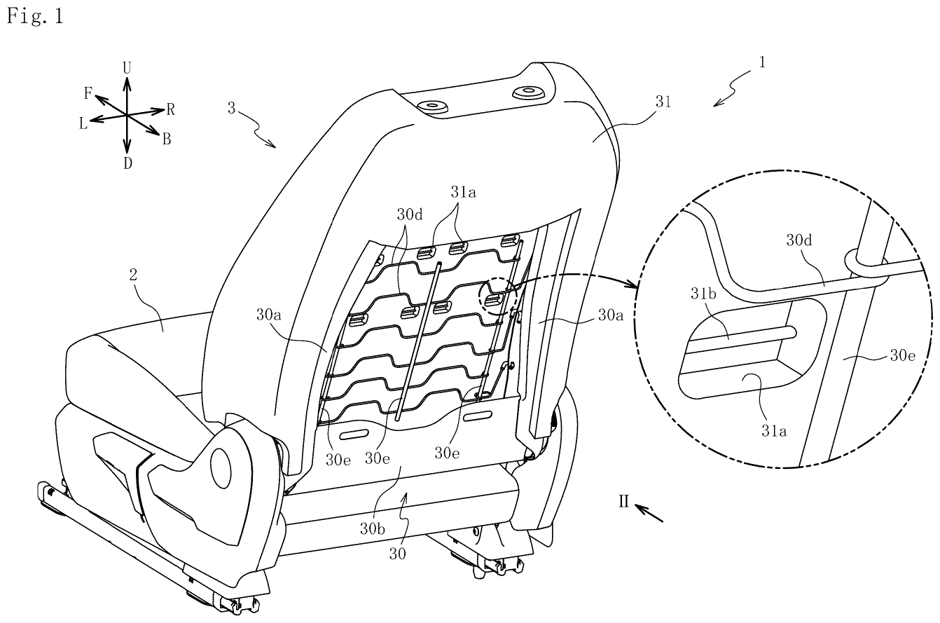

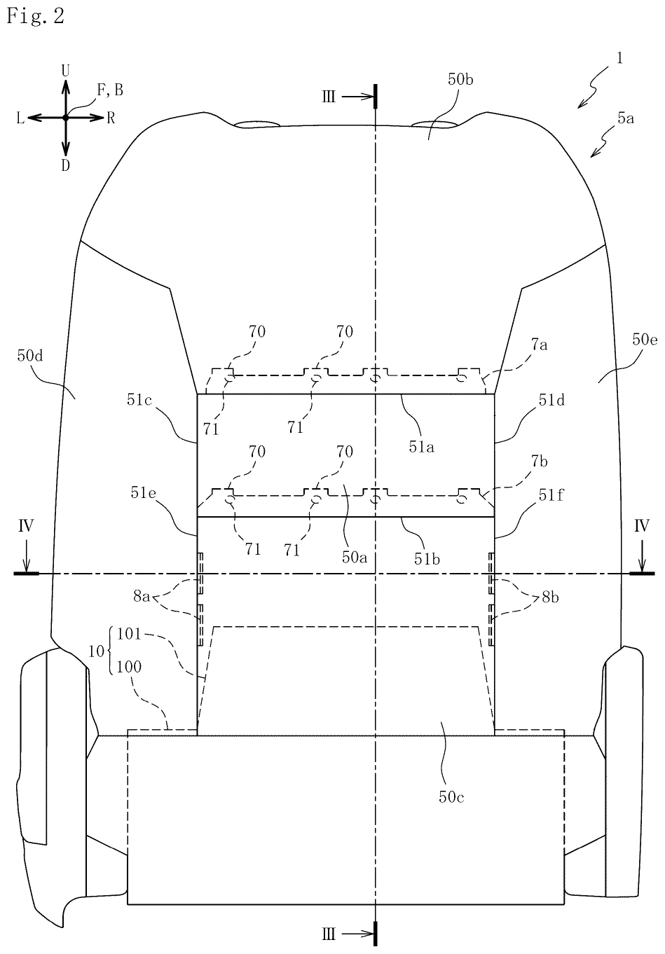

Hereinbelow, a preferred embodiment of the present invention will be described with reference to the accompanying drawings. First, the overall structure of a vehicle seat 1 will be described with reference to FIG. 1. FIG. 1 is a rear perspective view of the vehicle seat 1. Note that FIG. 1 illustrates a state without a skin (a back skin 5a illustrated in FIG. 2, or the like) covering the seatback 3. Furthermore, arrow U-D, L-R, and F-B directions in FIG. 1 respectively indicate an up-down direction, a left-right direction, and a front-rear direction of the vehicle seat 1 (the same applies to the other drawings).

As illustrated in FIG. 1, the vehicle seat 1 is a seat mounted in a vehicle, such as an automobile, and includes a seat cushion 2 forming a seat surface. A back frame 30 of the seatback 3 is tiltably connected to the rear end (the end on the arrow B side) of the seat cushion 2 via a reclining device.

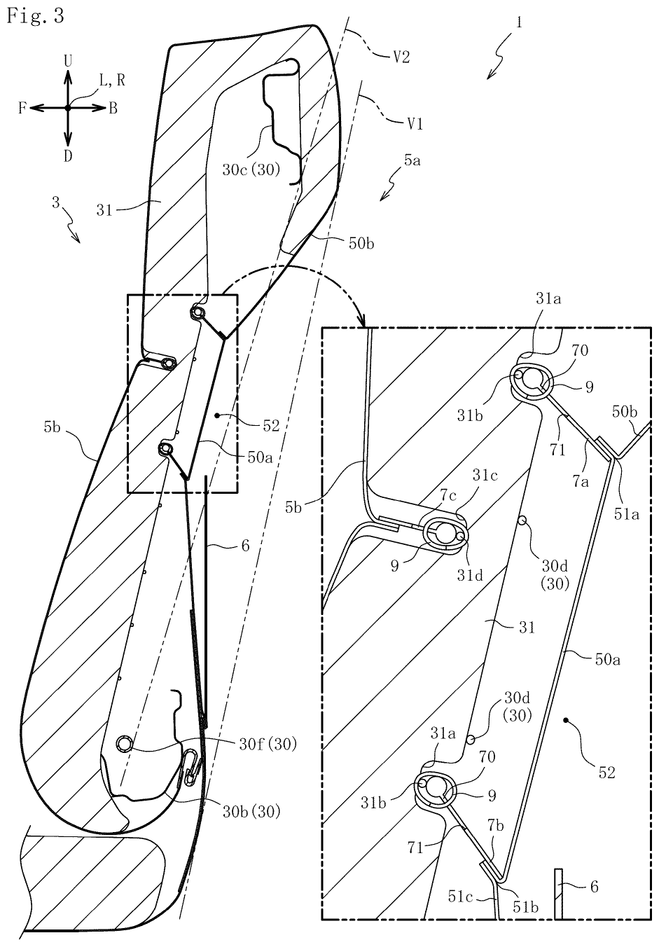

The back frame 30 includes side frames 30a extending in the up-down direction (arrow U-D direction), and the side frames 30a are provided in pairs with a space therebetween in the left-right direction (arrow L-R direction). The lower end portions of the pair of side frames 30a are connected to each other by a lower panel 30b extending in the left-right direction. The upper end portions of the pair of side frames 30a are connected to each other by an upper frame 30c (see FIG. 3) extending in the left-right direction.

The side frames 30a, the lower panel 30b, and the upper frame 30c constituting the back frame 30 form a substantially rectangular (trapezoidal) frame. Horizontal wires 30d and vertical wires 30e made of steel are attached to the inside of the frame.

The horizontal wires 30d are S-springs extending between the pair of left and right side frames 30a. There are a plurality of (six in this embodiment) horizontal wires 30d arranged in the up-down direction, and the vertical wires 30e extending linearly in the up-down direction are connected to the plurality of horizontal wires 30d. There are a plurality of (three in this embodiment) vertical wires 30e arranged in the left-right direction. A portion of a seat pad 31 (back pad) constituting a backrest is supported by the wires 30d and 30e.

The seat pad 31 is made of foam (soft foam) such as soft polyurethane foam. A plurality of recesses 31a (rear recesses) are formed in the rear surface of the seat pad 31. Two rows of recesses 31a, each row including four recesses 31a arranged in the left-right direction (that is, eight recesses in total), are provided in the up-down direction. Each recess 31a is provided with a back wire 31b (see the enlarged portion in FIG. 1) extending in the left-right direction.

Although not illustrated, the back wires 31b provided in the four recesses 31a arranged in a row in the left-right direction are made of a single straight wire embedded in the seat pad 31. The skin is attached by using the back wires 31b provided in the seat pad 31 and the vertical wires 30e provided in the back frame 30.

In the following description, of the skins covering the back frame 30 (seat pad 31), the skin covering the rear side of the back frame 30 is referred to as a back skin 5a (see FIG. 2), and the skin covering the front side is referred to as a front skin 5b (see FIG. 3). The skins 5a and 5b are made of fabric, synthetic leather, leather, or the like.

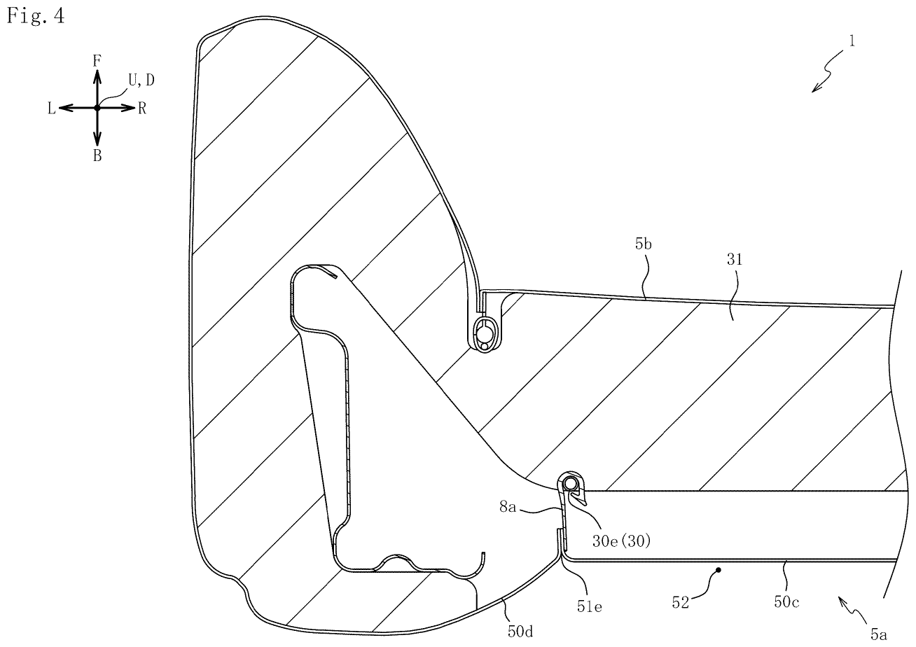

Next, a detailed structure of the vehicle seat 1 will be described with reference to FIGS. 2 to 4. FIG. 2 is a rear view of the vehicle seat 1 as viewed from the arrow II direction in FIG. 1, FIG. 3 is a partially enlarged sectional view of the vehicle seat 1 taken along line III-III in FIG. 2, and FIG. 4 is a partially enlarged sectional view of the vehicle seat 1 taken along line IV-IV in FIG. 2. In FIG. 2, a back pocket 6 (see FIG. 3) attached to the back skin 5a is not illustrated. In FIGS. 3 and 4, hatching in some cross-sections (the back skin 5a, suspenders 7a to 7c, and the like) is omitted for simplification of the drawings.

As illustrated in FIG. 2, the back skin 5a includes a rectangular first skin 50a disposed in a region including the center in the left-right direction (arrow L-R direction), and second to fifth skins 50b to 50e surrounding the four sides of the first skin 50a. The second skin 50b is positioned above (on the arrow U side of) the first skin 50a, and the third skin 50c is positioned below (on the arrow D side of) the first skin 50a. In a rear view of the vehicle seat 1 (the back frame 30), the fourth skin 50d is positioned to the left side of the first skin 50a, and the fifth skin 50e is positioned to the right side of the first skin 50a.

Note that the second skin 50b is formed by sewing together two skins that are arranged one above the other. However, in FIG. 2, the second skin 50b is illustrated as a single skin. Each of the fourth and fifth skins 50d and 50e is also formed by sewing together two skins arranged side by side in the left-right direction. However, in FIG. 2, the fourth and fifth skins 50d and 50e are each illustrated as a single skin.

There are seams 51a and 51b (boundary between the skins) formed between the first skin 50a and the second and third skins 50b and 50c by sewing the ends of the skins together. Furthermore, there are seams 51c and 51d formed between the first skin 50a and the fourth and fifth skins 50d and 50e by sewing the ends of the skins together.

The third skin 50c is formed in a rectangular shape having the same size in the left-right direction as the first skin 50a. The seams 51e and 51f, at which the ends of the third skin 50c and the fourth and fifth skins 50d and 50e are sewn together, extend vertically so as to extend the left and right seams 51c and 51d of the first skin 50a downward.

As illustrated in FIGS. 2 and 3, the suspenders 7a and 7b are sewn to the seam allowances (the ends of the first to third skins 50a to 50c) between the first skin 50a and the second and third skins 50b and 50c of the seams 51a and 51b.

The suspenders 7a and 7b have a sheet-like (flat plate-like) shape and made of a flexible resin, felt, or the like. The suspender 7a has four protrusions 70 arranged in the left-right direction (arrow L-R direction) at the front edge portion (the end on the arrow F side) thereof. The protrusions 70 are formed at positions corresponding to the recesses 31a (see the enlarged portion in FIG. 3) provided in the rear surface of the seat pad 31.

Furthermore, the suspenders 7a and 7b each have four attachment holes 71 arranged in the left-right direction, and the attachment holes 71 are formed at positions corresponding to the protrusions 70 in the front-rear direction (arrow F-B direction). As illustrated in the enlarged portion in FIG. 3, in a state in which the protrusions 70 are inserted into the recesses 31a in the seat pad 31, C-shaped hook members 9 (hog rings) passed through the attachment holes 71 are caulked and hooked to the back wires 31b. By doing so, the seam allowances of the seams 51a and 51b are pulled forward (arrow F side).

As illustrated in FIGS. 2 and 4, J-shaped hooks 8a are sewn to the seam allowances of the third and fourth skins 50c and 50d at the seam 51e. Hooks 8b having the same structure as the hooks 8a illustrated in FIG. 4 are also provided at the seam 51f (seam allowances of the third and fifth skins 50c and 50e) illustrated in FIG. 2. The hooks 8a and 8b are provided in pairs at a distance from each other in the up-down direction (arrow U-D direction) (see FIG. 2).

As a result of the hooks 8a and 8b being hooked on the vertical wires 30e (see FIG. 4) of the back frame 30, the seams 51e and 51f are pulled forward (arrow F side). Because the seam allowances of the seams 51e and 51f are connected (sewn) to the seam allowances of the left and right seams 51c and 51d of the first skin 50a, the seams 51c and 51d are also pulled forward by the hooks 8a and 8b.

With the structure in which the suspenders 7a and 7b and the hooks 8a and 8b pull the back skin 5a, a recess 52 (see FIGS. 3 and 4) having the first skin 50a (third skin 50c) as the bottom surface is formed in the back skin 5a.

As described above, in this embodiment, as a result of the pair of suspenders 7a and 7b spaced apart in the up-down direction and the pair of hooks 8a and 8b spaced apart in the left-right direction pulling the back skin 5a, the recess 52 recessed forward is formed in the back skin 5a. Thus, the recess can be formed in the rear surface of the seatback 3 without a resin panel board. Hence, a large space is provided for an occupant seated on the seat behind the vehicle seat 1 with reduced manufacturing cost of the vehicle seat 1.

Furthermore, because the hooks 8a and 8b connect the back skin 5a to the vertical wires 30e (see FIG. 4) supporting the seat pad 31, the vertical wires 30e can also serve the function of pulling the back skin 5a forward, in addition to the function of supporting the seat pad 31. Because this eliminates the need for additionally embedding the back wires 31b for pulling the back skin 5a in the seat pad 31, for example, the manufacturing cost of the vehicle seat 1 is reduced.

Meanwhile, the suspenders 7a and 7b connect the back skin 5a to the back wires 31b (see FIG. 3) embedded in the seat pad 31. Thus, the positions of the back wires 31b can be easily adjusted in accordance with the positions (for example, the attachment height) of the suspenders 7a and 7b by changing the positions where the back wires 31b are embedded in the seat pad 31. Because the arrangement of the suspenders 7a and 7b (the positions of the seams 51a and 51b) is less likely to be restricted, the degree of freedom in design of the vehicle seat 1 is improved.

Furthermore, by connecting the back skin 5a to the back wires 31b embedded in the seat pad 31, the seat pad 31 is pulled backward by the back skin 5a. Thus, the seat pad 31 is pressed against the horizontal wires 30d (see the enlarged portion in FIG. 3) and the vertical wires 30e (see FIG. 4) of the back frame 30. Thus, the seat pad 31 is stably supported by the wires 30d and 30e (the back frame 30).

The front skin 5b covering the front side of the seat pad 31 is pulled backward by the suspender 7c (see the enlarged portion in FIG. 3). The suspender 7c has the same structure as the suspenders 7a and 7b described above. A recess 31c (front recess) extending in the left-right direction is formed in the front surface of the seat pad 31, and a front wire 31d extending in the left-right direction is embedded in the recess 31c. By connecting the front wire 31d and the suspender 7c with the hook members 9, the front skin 5b is pulled backward.

As described above, in this embodiment, the back skin 5a and the front skin 5b are connected to the back wires 31b and the front wire 31d (front and rear surfaces of the seat pad 31) of the seat pad 31, respectively. This makes it possible to effectively suppress displacement of relative positions of the seat pad 31 and the skins 5a and 5b.

The back wire 31b that pulls the back skin 5a is embedded at a position shifted in the up-down direction from the front wire 31d that pulls the front skin 5b. In other words, the recesses 31a formed in the rear surface of the seat pad 31 and the recess 31c formed in the front surface of the seat pad 31 do not overlap each other in the thickness direction (arrow F-B direction) of the seat pad 31. This makes the cushioning of the seat pad 31 uniform.

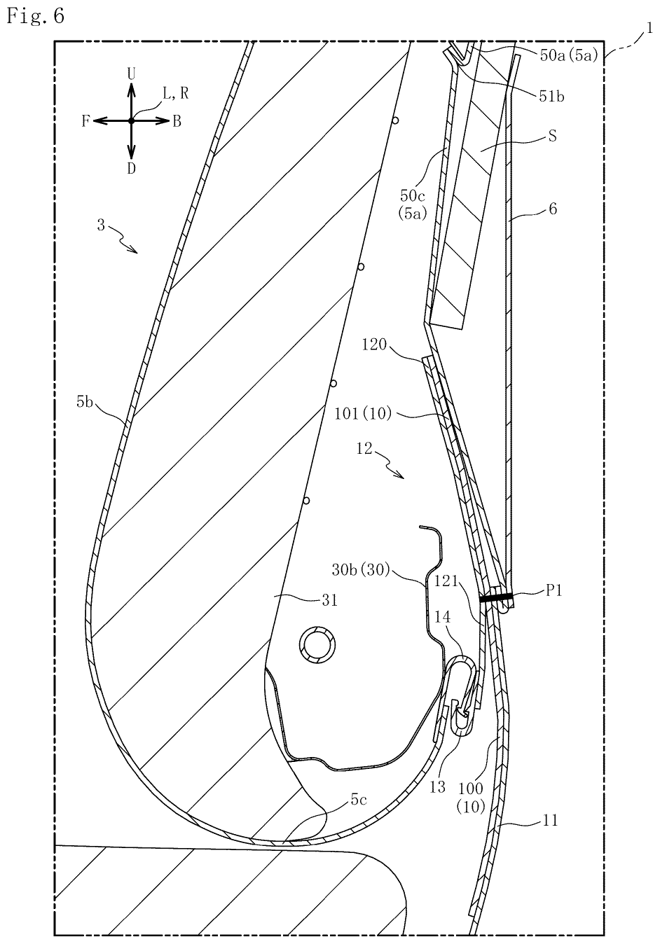

The back pocket 6 for storing an object S (see FIG. 6) is sewn to the rear surface of the back skin 5a. The upper end of the back pocket 6 is located above the seam 51b (see the enlarged portion in FIG. 3). The third skin 51c is covered with the back pocket 6, and the first skin 50a is exposed above the back pocket 6. Hence, the first skin 50a is required to have no wrinkles for better appearance of the rear side of the seatback 3.

In this embodiment, the seam allowances of the seams 51a and 51b along the upper and lower edges (two sides) of the first skin 50a are pulled forward by the suspenders 7a and 7b, and the seam allowances of the seams 51c to 51f along the left and right edges (two sides) of the first skin 50a are pulled forward by the hooks 8a and 8b (see FIG. 2). By pulling the four sides of the first skin 50a forward like this, the first skin 50a is less likely to wrinkle. Thus, the appearance of the vehicle seat 1 is improved.

Furthermore, because the first skin 50a is formed in a rectangular shape elongated in the left-right direction, it is preferable that the seams 51a and 51b (which are relatively long and extend in the left-right direction) along the long sides of the first skin 50a be pulled forward to reduce wrinkles in the first skin 50a. Thus, in this embodiment, the suspenders 7a and 7b extending in the left-right direction are sewn along the seam allowances of the seams 51a and 51b, and the seams 51a and 51b (the long side portions of the first skin 50a) are directly pulled forward by the suspenders 7a and 7b. Because this structure effectively prevents the first skin 50a from wrinkling, the appearance of the vehicle seat 1 is improved.

When it is intended to reduce wrinkles in the first skin 50a, for example, each of the seams 51a to 51d along the four sides of the first skin 50a can be directly pulled forward by the suspenders 7a and 7b or the hooks 8a and 8b.

In an example of such a structure, the hooks 8a and 8b sewn to the seam allowances of the seams 51e and 51f are omitted, and the seams 51c and 51d are directly pulled forward by the hooks or suspenders sewn to the seam allowances of the seams 51c and 51d. However, with this structure, the regions (areas) of the back skin 5a pulled forward are small. Hence, it is impossible to provide a large space for the seat behind the vehicle seat 1.

In another example, the seams 51c and 51d are directly pulled forward by hooks or suspenders sewn to the seam allowances of the seams 51c and 51d in addition to the suspenders 7a and 7b and the hooks 8a and 8b. This structure increases the regions of the back skin 5a pulled forward, while reducing wrinkles formed in the first skin 50a. However, the component count increases.

In contrast, the suspenders 7a and 7b of this embodiment are sewn to the seam allowances of the seams 51a and 51b along the two sides, i.e., the upper and lower sides, of the first skin 50a, and the hooks 8a and 8b are sewn to the seam allowances of the seams 51e and 51f extending downward from the two sides, i.e., the left and right sides, of the first skin 50a. No suspenders or hooks are provided at the left and right seams 51c and 51d of the first skin 50a. This structure reduces the component count while reducing wrinkles in the first skin 50a and increasing the regions of the back skin 5a pulled forward.

Furthermore, because the suspenders 7a and 7b inclined upward and forward (see the enlarged portion in FIG. 3) pull the seams 51a and 51b, the upper and lower sides (edges) of the first skin 50a are easily pulled upward. Furthermore, as described above, because the hooks 8a and 8b pull forward the seams 51e and 51f extending downward from the left and right sides of the first skin 50a (see FIG. 2), the left and right sides of the first skin 50a are easily pulled downward. In this way, by pulling the upper and lower sides of the first skin 50a upward and pulling the left and right sides downward, the first skin 50a is effectively prevented from wrinkling. Thus, the appearance of the vehicle seat 1 is improved.

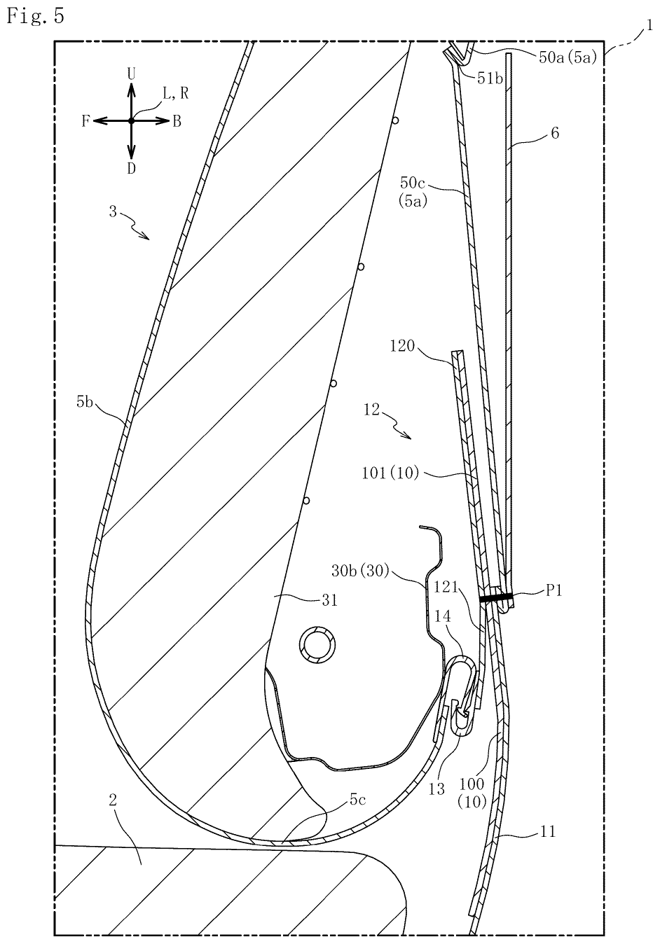

A virtual plane that is in contact with the outermost portions of the upper and lower parts on the rear side of the seatback 3, that is, a virtual plane that is in contact with the rear surfaces at the upper end (back skin 5a) and the lower end (carpet 11 described below with reference to FIG. 5) of the seatback 3 is defined as a virtual plane V1 (see FIG. 3). In this definition, because the first skin 50a is pulled further forward than the virtual plane V1, the recess 52 formed in the back skin 5a is deep. Thus, it is possible to provide a large space for the occupant seated on the seat behind the vehicle seat 1.

In particular, in this embodiment, the first skin 50a is pulled further forward than a virtual plane V2, which is located in front of the virtual plane V1. The virtual plane V2 will be described in detail. The lower panel 30b (see FIG. 3) connecting the pair of left and right side frames 30a (see FIG. 1) covers the lower frame 30f from the rear side. The lower frame 30f is a frame extending in the left-right direction (the direction perpendicular to the plane of the drawing of FIG. 3) and connecting the lower ends of the pair of side frames 30a, similarly to the lower panel 30b.

Hereinbelow, the lower panel 30b and the lower frame 30f (the frames constituting the lower end portion of the back frame 30) are collectively defined as a lower-part frame, and a virtual plane that is in contact with the upper frame 30c (upper-part frame) and the lower-part frame on the rear side of the back frame 30 is defined as the virtual plane V2 (see FIG. 3).

In this definition, the first skin 50a (the bottom surface of the recess 52) is pulled further forward than the virtual plane V2. In FIG. 3, the virtual plane V2 that is in contact with the upper frame 30c and the lower frame 30f is illustrated. However, also in the case where a virtual plane that is in contact with the upper frame 30c and the lower panel 30b on the rear side of the back frame 30 is illustrated, the first skin 50a is pulled further forward than the virtual plane. This increases the depth of the recess 52 formed in the back skin 5a, and thus makes it possible to provide a larger space for an occupant seated on the seat behind the vehicle seat 1.

As described above, in this embodiment, the recess 52 is formed of the back skin 5a alone, and a resin panel board is not used. This structure reduces the manufacturing cost of the vehicle seat 1. However, when an object S (see FIG. 6) is inserted into the back pocket 6, the back skin 5a pushed by the object S tends to be deformed forward. Thus, components such as the lower panel 30b provided inside the seatback 3 and a connector (not illustrated) of a harness attached to the lower panel 30b (hereinbelow, referred to as “components such as the lower panel 30b”) are likely to interfere with the object S.

In particular, in this embodiment, the first skin 50a is pulled further forward than the virtual planes V1 and V2 (see FIG. 3), and thus, the recess 52 is relatively deep. Hence, a component such as the lower panel 30b is likely to interfere with the object S when the object S is inserted into the back pocket 6. Such interference deteriorates ease of storing the object S in the back pocket 6. Thus, in this embodiment, a structure is adopted in which a component such as the lower panel 30b is covered from the rear side by a shield plate 10 (see FIG. 5). The detailed structure of the shield plate 10 will be described with reference to FIGS. 5 and 6.

FIG. 5 is a partially enlarged sectional view of the vehicle seat 1 in which a part of FIG. 3 is enlarged, and FIG. 6 is a partially enlarged sectional view of the vehicle seat 1 illustrating a state in which the object S is inserted into the back pocket 6 in the state in FIG. 5.

As illustrated in FIG. 5, the vehicle seat 1 includes the shield plate 10 that covers the components such as the lower panel 30b from the rear side. The shield plate 10 is formed in a plate shape from resin that has a higher bending rigidity than the back skin 5a and is softer (having a shore hardness of 50 to 100, for example) than the lower panel 30b.

The lower end of the back skin 5a (third skin 50c) is sewn (connected) to the central portion of the rear surface of the shield plate 10 in the up-down direction (arrow U-D direction). The shield plate 10 includes an exposed portion 100 extending downward from a sewing position P1 with respect to the back skin 5a and exposed from the back skin 5a, and an extension portion 101 extending upward from the sewing position P1.

The exposed portion 100 covers the seat cushion 2 from the rear side, and the rear surface (the surface facing the arrow B side) of the exposed portion 100 is covered with the carpet 11. The carpet 11 is formed in a sheet shape from a non-woven fabric or the like. The upper end of the carpet 11 is sewn between the back skin 5a (third skin 50c) and the shield plate 10 at the sewing position P1. The lower end of the back pocket 6 is also sewn to the back surface of the back skin 5a at the sewing position P1.

The extension portion 101 extends upward toward the inside of the back skin 5a from the sewing position P1 between the shield plate 10 and the back skin 5a, and the upper end of the extension portion 101 is located above the lower panel 30b. Thus, as illustrated in FIG. 6, when the object S is inserted into the back pocket 6, and the back skin 5a (third skin 50c) is pushed by the object S, the extension portion 101 of the shield plate 10 is deformed so as to be bent forward, together with the back skin 5a. As a result of the shield plate 10 (the extension portion 101) being bent forward, the shield plate 10 can restrict the contact between the object S and the component such as the lower panel 30b, and the insertion of the object S to the deeper part of the back pocket 6 can be guided along the shield plate 10 (the extension portion 101). Thus, ease of storing the object S in the back pocket 6 is improved.

When the extension portion 101 is provided inside the back skin 5a, the extension portion 101 may be deformed due to thermal influence from an electrical component (a seat heater or the like) provided inside the seatback 3. If the deformation of the extension portion 101 causes wrinkles in the back skin 5a, the appearance of the vehicle seat 1 is impaired.

To counter this problem, in this embodiment, the upper end of the extension portion 101 is positioned below the upper end of the back pocket 6. Thus, even if the extension portion 101 is deformed due to the thermal influence of the electrical component, the wrinkles in the back skin 5a caused by the deformation is covered by the back pocket 6. Thus, it is possible to prevent the appearance of the vehicle seat 1 from being impaired.

If, for example, the upper end of the extension portion 101 is connected (sewn) to the back skin 5a, when the object S is inserted into the back pocket 6 along the back skin 5a, the object S may be caught by the upper end of the extension portion 101. Hence, in this embodiment, the upper end of the extension portion 101 is not connected to the back skin 5a. Because this prevents the object S inserted along the back skin 5a from being caught by the upper end of the extension portion 101, ease of storing the object S in the back pocket 6 is improved.

Although not illustrated, the left and right ends of the extension portion 101 are also not connected to the back skin 5a. More specifically, the entirety of the extension portion 101 is not connected (sewn) to the back skin 5a except for the sewing position P1 between the shield plate 10 and the back skin 5a. Hence, deformation of the extension portion 101 is not restricted by the back skin 5a. With this structure, when the extension portion 101 is pushed by the object S, the extension portion 101 of the shield plate 10 is easily bent forward. Because the insertion of the object S to the deeper part of the back pocket 6 is easily guided by the extension portion 101, ease of storing the object S in the back pocket 6 is improved.

Furthermore, because the entirety of the extension portion 101 is not connected (sewn) to the back skin 5a, even if the extension portion 101 is deformed due to thermal influence as described above, the influence of the deformation on the appearance of the back skin 5a is reduced. Thus, the appearance of the vehicle seat 1 is improved.

As described above, in this embodiment, the entirety of the extension portion 101 is not connected to the back skin 5a. Thus, the extension portion 101 is easily bent forward when the object S is stored. When the extension portion 101 comes into contact with a component such as the lower panel 30b as the extension portion 101 is deformed, noise due to the contact is generated. Thus, the carpet 12 (buffer material) is provided on the front surface of the extension portion 101.

The carpet 12 includes a covering portion 120 that covers substantially the entire front surface of the extension portion 101 of the shield plate 10, and a hanging portion 121 that hangs downward from the sewing position P1 with respect to the shield plate 10. The covering portion 120 and the hanging portion 121 are formed into a single sheet from a non-woven fabric or the like. Although the upper end of the carpet 12 (the covering portion 120) is sewn to the upper end of the shield plate 10 (the extension portion 101), the carpet 12 may be joined to the shield plate 10 with an adhesive or the like.

By covering the front surface of the extension portion 101 with the carpet 12 (the covering portion 120), when the extension portion 101 is pushed by the object S and is bent forward, the carpet 12 comes into contact with a component such as the lower panel 30b. Because the carpet 12 is softer than the extension portion 101, noise generated by the contact between the lower panel 30b and the carpet 12 is reduced.

The entirety of the hanging portion 121 of the carpet 12 is not connected to the exposed portion 100 of the shield plate 10, and a hook 13 is sewn to the lower end of the hanging portion 121. The hook 13 is a member to which the front skin 5b is hooked.

The lower end of the front skin 5b is folded back to the rear side (the arrow B side) along the lower surface of the seat pad 31. When the folded portion (the skin covering the lower side of the seatback 3) is assumed to be a lower skin 5c, a hook 14 sewn to the rear end of the lower skin 5c is hooked to the hook 13 of the hanging portion 121. In this way, the lower skin 5c (front skin 5b) is connected to the carpet 12.

By connecting the lower skin 5c (the lower end of the front skin 5b) to the hanging portion 121 of the carpet 12, which is not connected to the shield plate 10, in this way, even when the shield plate 10 is deformed when the object S is inserted into the back pocket 6, the front skin 5b or the lower skin 5c is prevented from being influenced by the deformation. Thus, for example, it is possible to prevent a part of the front skin 5b from being pulled backward and the lower end of the front skin 5b from wrinkling due to the deformation of the shield plate 10 when the object S is stored. Thus, the appearance of the vehicle seat 1 is improved.

As illustrated in FIG. 2, the exposed portion 100 of the shield plate 10 is formed in a rectangular shape elongated in the left-right direction, and the extension portion 101 is formed in a trapezoidal shape which is smaller in the left-right direction than the exposed portion 100. Although not illustrated, the dimension of the extension portion 101 in the left-right direction is smaller than that of the back pocket 6 (see FIG. 5), and the left and right ends of the extension portion 101 are located on the inner side in the left-right direction of the left and right ends (seams 51e and 51f) of the back pocket 6. The upper end of the extension portion 101 is located below the seam 51b. This prevents the extension portion 101 from interfering with sewing when the back pocket 6 is sewn to the back skin 5a or when the first skin 50a and the third skin 50c are sewn. Thus, the efficiency of sewing the back pocket 6 is improved.

Although the present invention has been described based on the above embodiment, the present invention is not limited to the above embodiment. It can be easily inferred that various modifications and improvements can be made without departing from the spirit of the present invention.

In the embodiment, the case where the seams 51a and 51b of the back skin 5a are connected to the back wires 31b of the seat pad 31 by the suspenders 7a and 7b, and the seams 51e and 51f are connected to the vertical wires 30e of the back frame 30 by the hooks 8a and 8b has been described. However, the present invention is not necessarily limited thereto.

For example, the seams 51a and 51b of the back skin 5a may be connected to the horizontal wires 30d. Furthermore, for example, the seams 51e and 51f may be connected to the back wires 31b. In this case, the positions where the back wires 31b are embedded in the seat pad 31 may be changed. More specifically, the wires (the arrangement of the wires) used when the back skin 5a is pulled may be appropriately changed according to the position of the seams of the back skin 5a.

Furthermore, the back skin 5a can be pulled forward by the hooks 8a and 8b sewn to the seam allowances of the seams 51a and 51b, and the back skin 5a can be pulled forward by the suspenders 7a and 7b sewn to the seam allowances of the seams 51e and 51f. Furthermore, the back skin 5a may be pulled forward by the suspenders 7a and 7b or the hooks 8a and 8b sewn to the seam allowances of the seams 51c and 51d, and, when seams other than the seams 51a to 51f are formed in the back skin 5a, such other seams may be pulled forward.

In the embodiment, the case where the first skin 50a and the third skin 50c are each made of a single skin has been described. However, for example, the first skin 50a and the third skin 50c may be formed of a plurality of skins sewn together, or the first skin 50a and the third skin 50c may be joined to form a single skin.

In the embodiment, the case where the seams 51a and 51b are pulled forward by the pair of suspenders 7a and 7b inclined upward and forward has been described. However, the present invention is not necessarily limited to this. For example, one or both of the pair of suspenders 7a and 7b may be inclined downward and forward.

In the embodiment, the metal back wires 31b have been described as an example of an engaging member (on which the suspenders 7a and 7b are hooked) embedded in the seat pad 31. However, the present invention is not necessarily limited thereto. For example, the suspenders 7a and 7b may be hooked on a resin component embedded in the seat pad 31. In other words, the engaging member embedded in the seat pad 31 is not limited to the form described above as long as the engaging member can pull the back skin 5a forward.

In the embodiment, the case where the entirety of the extension portion 101 of the shield plate 10 is not connected to the back skin 5a (third skin 50c) has been described. However, the present invention is not necessarily limited thereto. For example, one or both of the upper side and the left and right sides of the extension portion 101 may be sewn to the back skin 5a (third skin 50c).

In the embodiment, the case where the front surface of the extension portion 101 is covered with the sheet-like carpet 12 (the covering portion 120) that is softer than the shield plate 10 has been described. However, the present invention is not necessarily limited thereto. For example, the carpet 12 may be omitted.

In the embodiment, the case where the hanging portion 121 that is not connected to the shield plate 10 (the exposed portion 100) is provided at the lower end of the carpet 12, and the front skin 5b is connected to the hanging portion 121 via the lower skin 5c has been described. However, the present invention is not necessarily limited to this. For example, the hanging portion 121 may be omitted, or the lower skin 5c (the lower end of the front skin 5b) may be connected to the exposed portion 100 of the shield plate 10 or the covering portion 120 of the carpet 12.

In the embodiment, the case where the left and right ends of the extension portion 101 are positioned on the inner side with respect to the left and right ends of the back pocket 6 in the left-right direction has been described. However, the left and right ends of the extension portion 101 may be positioned on the outer side with respect to the left and right ends of the back pocket 6 in the left-right direction.

### DESCRIPTION OF REFERENCE NUMERALS

1 vehicle seat
3 seatback
30 back frame
30e vertical wire (support member)
31 seat pad
31a recess (rear recess)
31b back wire (first engaging member)
31c recess (front recess)
31d front wire (second engaging member)
5a back skin
50a first skin (bottom skin)
51a first seam
51b second seam
51c third seam
51d fourth seam
51e fifth seam
51f sixth seam
52 recess
7a, 7b suspender (suspension member, first suspension member)
7c suspender (third suspension member)
8a, 8b hook (suspension member, second suspension member)
V1 virtual plane (first virtual plane)
V2 virtual plane (second virtual plane)

What is claimed is:

1. A vehicle seat comprising:
a seatback including: a seat pad; a back frame having a support member that supports, on a front surface thereof, the seat pad; a back skin that covers a rear side of the back frame; and a suspension member that connects the back skin to at least one of the support member and a first engaging member embedded in the seat pad, wherein
the suspension member includes at least a pair of first suspension members spaced apart in an up-down direction and a pair of second suspension members spaced apart in a left-right direction, and
the back skin is pulled forward by the pair of first suspension members and the pair of second suspension members so as to form a recess recessed forward in the back skin.

2. The vehicle seat according to claim 1, wherein at least one of the pair of first suspension members and the pair of second suspension members connect the back skin to the support member.

3. The vehicle seat according to claim 1, wherein at least one of the pair of first suspension members and the pair of second suspension members connect the back skin to the first engaging member.

4. The vehicle seat according to claim 1, wherein
the back skin includes a rectangular bottom skin that forms a bottom surface of the recess,
the back skin has a first seam and a second seam extending along upper and lower sides of the bottom skin, and a third seam and a fourth seam extending along left and right sides of the bottom skin,
the pair of first suspension members pull the first seam and the second seam forward, and
the pair of second suspension members pull the third seam and the fourth seam forward.

5. The vehicle seat according to claim 4, wherein
the back skin has a fifth seam and a sixth seam extending downward from the bottom skin along the third seam and the fourth seam,
the pair of first suspension members are sewn to seam allowances of the first seam and the second seam, and
the pair of second suspension members are sewn to seam allowances of the fifth seam and the sixth seam.

6. The vehicle seat according to claim 5, wherein the first seam and the second seam are pulled forward by the pair of first suspension members that are inclined upward and forward.

7. The vehicle seat according to claim 4, wherein the bottom skin is pulled further forward than a first virtual plane that is in contact with a rear surface of an upper end and a rear surface of a lower end of the seatback.

8. The vehicle seat according to claim 7, wherein
the back frame includes: a pair of left and right side frames extending in the up-down direction; an upper-part frame connecting upper ends of the pair of side frames to each other in the left-right direction; and a lower-part frame connecting lower ends of the pair of side frames to each other in the left-right direction, and
the bottom skin is pulled further forward than a second virtual plane that is in contact with the upper-part frame and the lower-part frame on a rear side of the back frame.

9. The vehicle seat according to claim 3, wherein
the seatback includes a front skin covering a front side of the seat pad, and a third suspension member connecting the front skin to a second engaging member embedded in the seat pad,
the seat pad has a rear recess formed in a rear surface of the seat pad and in which the first engaging member is embedded, and a front recess formed in a front surface of the seat pad and in which the second engaging member is embedded, and
the rear recess and the front recess are formed at positions shifted from each other in the up-down direction.
